(19) United States
(12) Patent Application Publication
(10) Pub. No.: US 2008/0262954 A1
(43) Pub. Date: Oct. 23, 2008

(54) GENERATION OF ELECTRONIC NEGOTIABLE INSTRUMENTS USING PREDEFINED ELECTRONIC FILES FOR PROVIDING PROMISE OF PAYMENT

(75) Inventor: Robert B. Nally, Waterloo (CA)

Correspondence Address: OCCHIUTI ROHLICEK & TSAO, LLP, 10 FAWCETT STREET, CAMBRIDGE, MA, 02138, US

(73) Assignee: RDM Corporation

(21) Appl. No.: 12/014,389

(22) Filed: Jan. 15, 2008

Related U.S. Application Data
(60) Provisional application No. 60/880,450, filed on Jan. 16, 2007.

(51) Int. Cl. G06Q 10/00

(52) U.S. Cl. 705/35

(57) ABSTRACT

A method for providing an electronic negotiable instrument as a promise for payment for a selected payee over a communications network, the method comprising: generating the electronic negotiable instrument for the selected payee with instrument information from a payor; receiving a specified mode of communication associated with the payee; sending a message to the selected payee over the communications network using the specified mode of communication to inform the payee of the availability of the electronic negotiable instrument; receiving a request over the communications network from the payee for the electronic negotiable instrument; authenticating the payee request and a specified receipt address; and forwarding the electronic negotiable instrument over the communications network to the specified receipt address. The electronic negotiable instrument is capable of being reproduced in a paper form in accordance with predefined standards, such as Check 21 in the United States.

### CROSS-RELATED REFERENCE

This application claims the benefit of U.S. Provisional Application No. 60/880,450, filed on Jan. 16, 2007, the contents of which are hereby incorporated by reference in its entirety.

### BACKGROUND OF THE INVENTION

The present invention relates to electronic promise of payment instruments for facilitating financial transactions.

Currently, electronic financial transactions (e.g. debit, credit card, etc.) are relied upon to provide payment for wares and services. These financial transactions can be referred to as a ‘push’-initiated transactions, such that the payer directs his or her bank to take existing funds from his or her account and transfer them to the payee's bank, where the payee can then draw the funds out. As a result, current electronic financial transactions cannot “bounce”, because the bank will only process the order if the payer has sufficient funds to cover the payment. However, a disadvantage with current electronic payment transactions is that the payer receives no benefit of “float” or money supply that is an advantage when making payment with promise payment forms such as cheques.

Cheques and other forms of promise payment have been in decline for many years, both for point of sale transactions (for which credit cards and debit cards are increasingly preferred) and for third party payments (e.g. bill payments), where the decline has been accelerated by the emergence of telephone banking and online banking. Being paper-based, cheques are costly for banks to process in comparison to electronic payments, so banks in many countries now discourage the use of cheques, either by charging for cheques or by making the alternatives more attractive to customers. The rise of Automated Teller Machines (ATMs) has also led to an era of easy access to cash, which made the necessity of writing a cheque to someone because the banks were closed a thing of the past.

Despite having a long history of well-developed, complex financial networking, the United States still relies heavily on cheques. When sending a payment by online banking in the United States, the sending bank usually mails a cheque to the payee's bank rather than sending the funds electronically. This is changing rapidly, however, and certain companies with whom a person pays with a cheque will turn that cheque into an ACH or electronic transaction. Banks try to save time processing cheques by sending them electronically between banks. However, one disadvantage with the current chequing system is that paper cheques have to be ordered, printed, received by the a bank customer, and then used by the customer as payment. Further, paper resources are wasted in generation of the paper cheques. Further, there is an appreciable shipping time lag, as paper cheques must be physically forwarded via traditional physical mail routes (post office, express companies, etc.).

Another disadvantage with state of the art checking systems is that a payee may doubt the autenticity of the source of the check from a payor.

### SUMMARY

It is an object of the present invention to provide a system and method providing paperless electronic negotiable instruments for use as promise for payment.

Currently, electronic financial transactions (e.g. debit, credit card, etc.) are relied upon to provide payment for wares and services. These financial transactions can be referred to as a ‘push’-initiated transactions, such that the payer directs his or her bank to take existing funds from his or her account and transfer them to the payee's bank, where the payee can then draw the funds out. A disadvantage with state of the art checking systems is that a payee may doubt the autenticity of the source of the check from a payor. Contrary to current systems there is provided a method for providing an electronic negotiable instrument as a promise for payment for a selected payee over a communications network, the method comprising: generating the electronic negotiable instrument for the selected payee with instrument information from a payor; receiving a specified mode of communication associated with the payee; and sending a message to the selected payee over the communications network using the specified mode of communication to inform the payee of the availability of the electronic negotiable instrument.

An aspect provided is a method for providing an electronic negotiable instrument as a promise for payment for a selected payee over a communications network, the method comprising: generating the electronic negotiable instrument for the selected payee with instrument information from a payor; receiving a specified mode of communication associated with the payee; and sending a message to the selected payee over the communications network using the specified mode of communication to inform the payee of the availability of the electronic negotiable instrument.

A further aspect provided is a method for providing an electronic negotiable instrument as a promise for payment for a selected payee over a communications network, the method comprising: generating the electronic negotiable instrument for the selected payee with instrument information from a payor; receiving a specified mode of communication associated with the payee; sending a message to the selected payee over the communications network using the specified mode of communication to inform the payee of the availability of the electronic negotiable instrument; receiving a request over the communications network from the payee for the electronic negotiable instrument; authenticating the payee request and a specified receipt address; and forwarding the electronic negotiable instrument over the communications network to the specified receipt address.

### BRIEF DESCRIPTION OF THE DRAWINGS

A better understanding of these and other embodiments of the present invention can be obtained with reference to the following drawings and detailed description of the preferred embodiments, in which:

FIG. 1 is a block diagram of a payment system;

FIG. 2 shows further details of an electronic file of the payment system of FIG. 1;

FIG. 3 shows further details of a resultant electronic negotiable instrument of the electronic file of FIG. 1;

FIG. 4 shows a block diagram of a processing application for the electronic file and the electronic negotiable instrument of FIG. 2;

FIG. 5 shows a block diagram of an example computing device of the system of FIG. 1;

FIG. 6 shows an example operation of the processing application of FIG. 4;

FIG. 7 shows a further embodiment of the system of FIG. 1;

FIG. 8 shows an example operation of the system of FIG. 7.

### DETAILED DESCRIPTION OF THE PREFERRED EMBODIMENT

The following detailed description of the embodiments of the present invention does not limit the implementation of the invention to any particular computer programming language. The present invention may be implemented in any computer programming language provided that the OS (Operating System) provides the facilities that may support the requirements of the present invention. One embodiment is the Java computer programming language (or other computer programming languages in conjunction with C/C++) or a structured definition language (e.g. HTML, XML, etc.) that can be associated with instructions/script as desired. Any limitations presented would be a result of a particular type of operating system, computer programming language, or data processing system and would not be a limitation of the present invention as claimed.

### Payment Environment 100

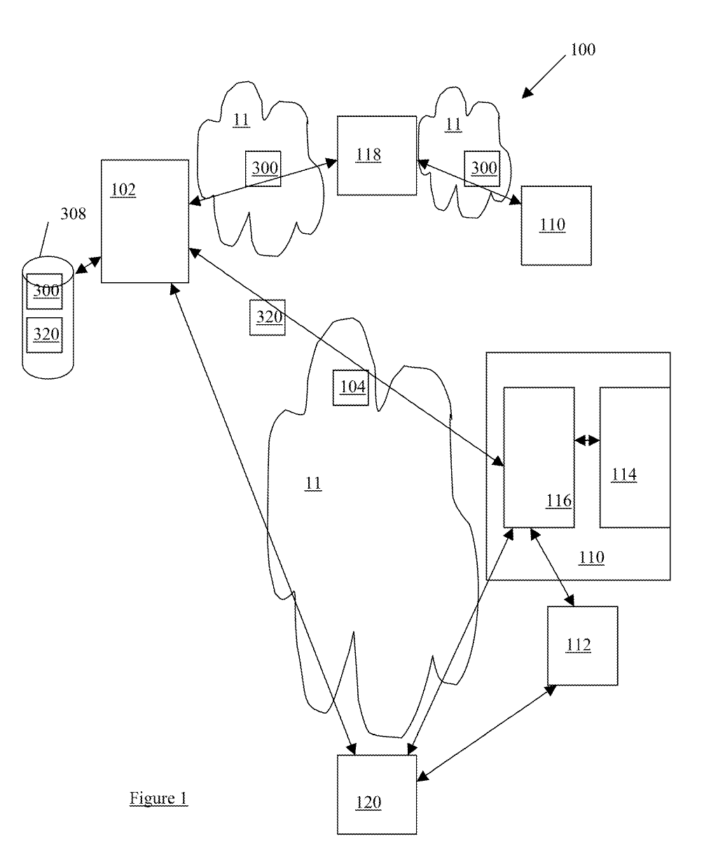

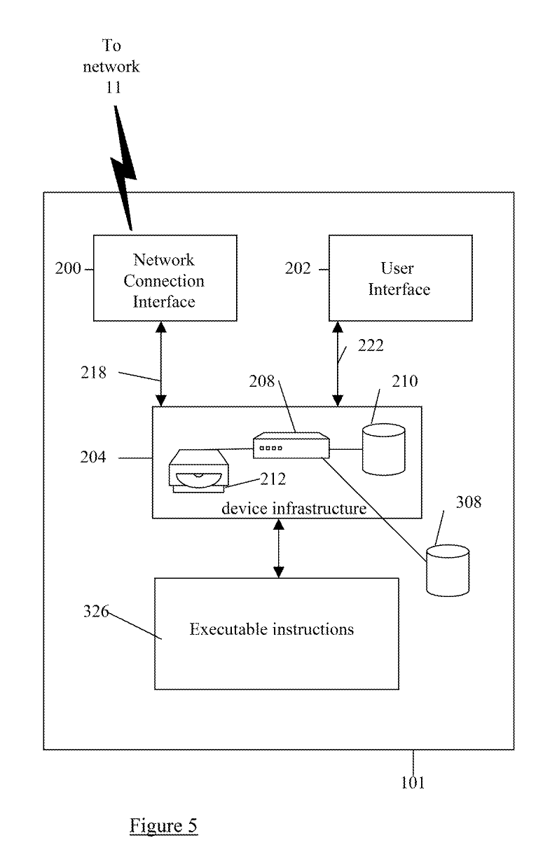

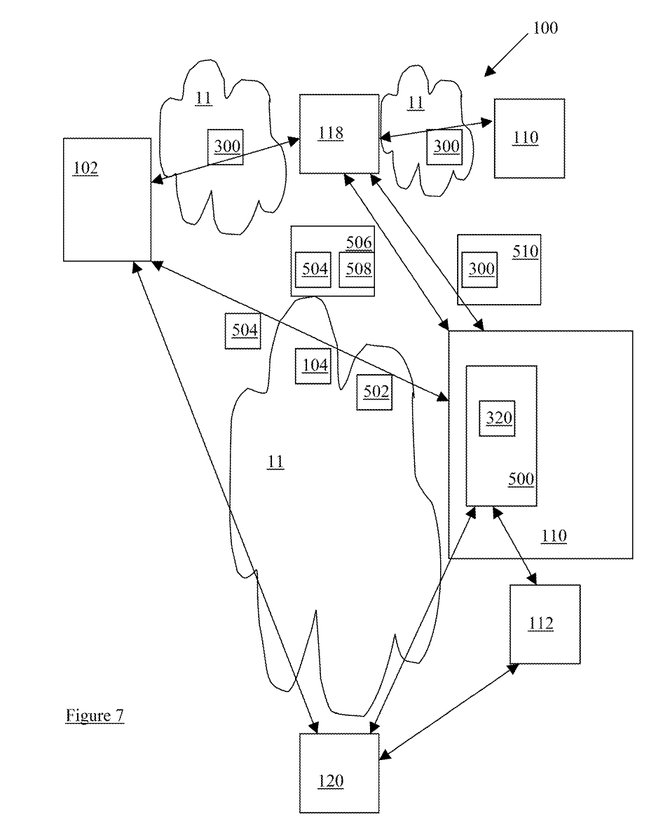

Referring to FIG. 1, a payment environment 100 includes a payer 102 operating a computing device 101 (see FIG. 5) that is connected by a network 11 (e.g. the Internet) to a financial institution 110. The computing device 101 can be such as but not limited to: desktop computer; wireless device; PDA; laptop; and generic digital device, for example. The payer 102 can be referred to as a customer of the financial institution 110 (or other third party 112). The customer 102 requests via a request message 104 one or more electronic files 320 from the financial institution 110 (or other associated third party 112), which are suitable for generation of electronic negotiable instruments 300, further described below. The request message 104 can contain the type of electronic negotiable instrument 300 (e.g. an electronic personal cheque with personalized details and background), details of the payer (e.g. name, address, etc.) that will be filling out the corresponding electronic file 320, the network 11 address of the target computing device 101 to be receiving the electronic file(s) 320, the unique encryption key (or part thereof) or other personal identification number (PIN) or alphanumeric string for use in digitally signing the resultant electronic negotiable instruments 300, information on the payee (e.g. name, address, etc.), and other information as desired. It is also recognized that the request message 104 could be intended for generation of the electronic file(s) 320 to be held in a payor account 500 (see FIG. 7) and therefore hosted by the financial institution 110, for example, on behalf of the payor 102.

Referring again to FIG. 1, the financial institution 110 can have a network interface 116 (e.g. a website) that is configured to receive the request message 104. The network interface 116 can communicate with a file generator 114 (or in conjunction with the third party 112) to satisfy the requirements of the request message 104. For example, the file generator 114 could check the credentials of the customer 102 to confirm that they are a credit worthy individual registered with the financial institution and that they are authorized to obtain the requested electronic file(s) 320, i.e. similar to the credentials and associated information required to order paper cheques, a paper certified bank draft, etc. Upon confirmation of the customer 102, the file generator 114 inserts the required payment data 322 and optional generation data 324 into the electronic file 320 for subsequent use by the customer 102 in generation of the electronic negotiable instrument 300, either locally on the computing device 101 or remotely through the financial institution 110 website as desired.

For example, once received by the customer 102, the electronic file 320 can be used by the customer 102 for submitting promise of payment (as the electronic negotiable instrument 300) to a payee 118 (e.g. store, individual, etc.) for wares and/or services obtained by the customer 102. It is recognized that the electronic negotiable instrument 300 can be transmitted over the network 11 (intra- or extranet for example) electronically to the payee 118. In turn, the payee 118 would submit the promise of payment represented by the electronic negotiable instrument 300 to the financial institution 110 in exchange for money, for example.

Further, with respect to FIG. 1, the customer 102 and/or financial institution 110 or third party 112 can use the services of a certification authority 120 for the obtainment of digital certificates for inclusion in the electronic file 320 and/or the electronic negotiable instrument 300. It is recognized that the certificate authority or certification authority (CA) 120 is an entity which issues digital certificates for use by other parties. The certification authority (CA) 120 is an example of a trusted third party, and is characteristic of many public key infrastructure (PKI) schemes. For example, the financial institution 120 will issue a public key certificate to the financial institution 110 and/or payer 102 which states that the certification authority (CA) 120 attests that the public key contained in the certificate (signature/certification financial institution 110 and/or payer 102) belongs to the person, organization, server, or other entity noted in the certificate. A certification authorities (CA) 120 obligation in such schemes is to verify an applicant's credentials, so that users (relying parties) can trust the information in the certification authority's (CA) 120 certificates. The usual idea is that if the user trusts the certification authority (CA) 120 and can verify the certification authority's (CA) 120 digital signature, then they can also verify that a certain public key does indeed belong to whomever is identified in the certificate.

Assuring correctness of match between data (e.g. digital signature) and the signing/issuing entity, when the data are presented to the certification authority (CA) 120 (perhaps over an electronic network), and when the credentials of the person/company/program asking for a certificate is likewise presented can be done by the certification authority (CA) 120 using a number of methods. For example, the certification authority (CA) 120 can use a combination of authentication techniques including leveraging government bureaus, the payment infrastructure, third parties' databases and services, and custom heuristics. Notaries can be used in some cases to personally know the party whose signature is being notarized. It is recognized that the electronic file 320 and/or the electronic negotiable instrument 300 can contain (via the data 322,324) a certified signature/identification of the payer and/or the issuer of the electronic file 320 (e.g. the financial institution 110.

### An Example Embodiment of the Payment System 100

Referring again to FIG. 1, operation of the system 100 can facilitate the elimination of the need for paper based check payment origination but can take advantage of all existing paper based check payment legislation (such as Check 21 in the US), systems, IRD, networks, policies, processes and procedures, for example. This system 100 also takes advantage of all and any type of computer, wireless device, PDA, laptop, portable or not, digital device 101, etc. For example, the reproducible image of the negotiable instrument 300 can be in accordance with a predefined standard for reproduce paper, such as Check 21

The system 100 can work as follows; a person or company (e.g. payer 102) who wants to take full advantage of the check electronfication payment system 100 simply goes in to their bank (e.g. financial institution 110) and signs up for, or registers for, the paperless payment processing service (e.g. electronic negotiable instruments 300) or they can do it remotely with their bank 110, over the web. The person or company (thereinafter called the customer 102) registers with the bank 110 by whatever means for the service. The customer 102 can select a customized digital image (e.g. represented by generation data 324—see below) unique to them (e.g. custom) electronic checks they wish to use. The bank 110 provides the customer 102 with a unique encryption key or PIN that can be used to digitally sign the electronic checks (e.g. electronic negotiable instruments 300) or the bank 110 makes an actual coded/encrypted digitized version of the customer's 102 actual physical signatures or any other secure biometric unique personal identifier (e.g. represented in the data 322,324—see below).

In one example, the customer 102 provides the bank 110 (could also be done through the customers 102 secure bank web site 116) with their “target” digital device 101 email address of the customers 102 choice. The bank 110 then downloads (or the customer 102 down loads off their secure bank 110 website), using a unique encryption key or PIN, a specific number of unique personal or digitized electronic files 320 with the usual MICR account #'s etc. as with any normal type of paper check, to the target customer digital device 101. These electronic files 320 can then be filled out locally on the payee's 102 computing device 101 (or accessed and filled out on a Web site 116) with corresponding data values (monetary amount, date, payee, etc.) to produce electronic checks (e.g. the electronic negotiable instruments 300). It is recognized that the electronic files 320 and/or the corresponding electronic negotiable instruments 300 can be digitally signed and MACT'ed by the bank 110 for security, as desired.

The customer 102 pays the bank 110 fees for these electronic files 320 and the processing of the resultant electronic negotiable instruments 300 (when presented by the payee) as with normal paper checks. For example, in one embodiment, the customer 102 can fill out the payee, amounts, dates, etc and sign the electronic negotiable instruments 300 with their PIN/digital signature on their PDA, laptop or any other wireless' or connected digital device 101 and transmit the electronic negotiable instruments 300 to the person/company to be paid (e.g. payee). For example, a person with their custom digital electronic negotiable instrument 300 on their PDA can walk up to a POS terminal and using a blue tooth or other wireless or non-contact or contact means transmit the digitally signed and digitally filled out electronic negotiable instruments 300 to the payee's POS or PDA device 101 by laptop or whatever means or they could email the electronic negotiable instruments 300, as desired.

Further, once the payee 118 receives the signed electronic negotiable instrument 300, they can then transmit the electronic promise of payment to their bank 110, by email or other means, for processing and payment as a financial transaction into their account, over the bank check image settlement network. As with traditional electronic financial transactions, when done, processing of the electronic negotiable instrument 300 results in removal of corresponding funds from the payers 102 account once the signed electronic negotiable instrument 300 gets to the payees bank 110, and is verified as being authentic by all the normal means by the payor's bank 110.

Further, it is recognized that the payor 102 can keep an “electronic check book” (e.g. the payor account 500—see FIG. 7) on their digital device 101 and the payor's bank 110 can provide them with access to or an actual electronic check image statement. An actual paper check (IRD Image Replacement Document) could be fully reproduced, i.e. printed with MICR etc., from the electronic negotiable instrument 300 as a reproducible image 321, and be fully legally valid and processed from the actual digital image.

One advantage of this payment system 100 is that it can facilitate elimination of paper initiation from the check payment systems, yet fully conform to and comply with existing check payment laws, process, procedures, networks, rules etc. The payment system 100 also has an advantage of security and convenience. Further, it is recognized that existing paper check printers could provide the custom check images and MICR lines etc., as generated from the electronic negotiable instrument 300, as further described below. This payment system 100 could also facilitate storing the electronic negotiable instrument 300 and/or corresponding electronic files 320 on “Smart Cards” or stored payment or other types of electronic cards and the card could be used to carry and transfer the electronic negotiable instrument 300 and/or corresponding electronic files 320 to other devices 101, etc.

Further, the payor's bank 110 could keeps a data base of the payors unique/digital check images (or any of contents of the electronic negotiable instrument 300), which can be used to match or verify to the check sent by the payee 118 to the payor's 102 account for payment. In fact, the payor 102 could also email a copy of the electronic negotiable instrument 300 to the payee 118 and to their own email for extra security and verification purposes, as desired.

### Electronic File 320

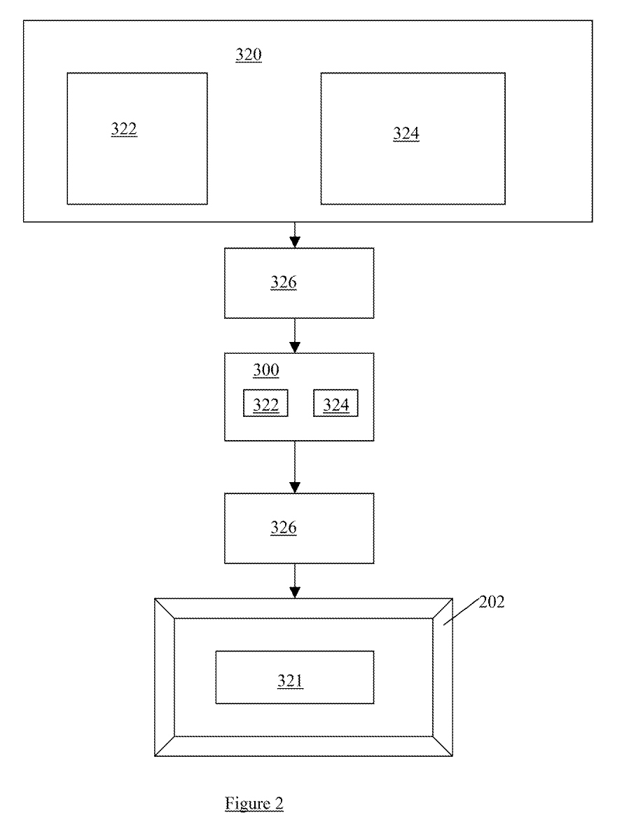

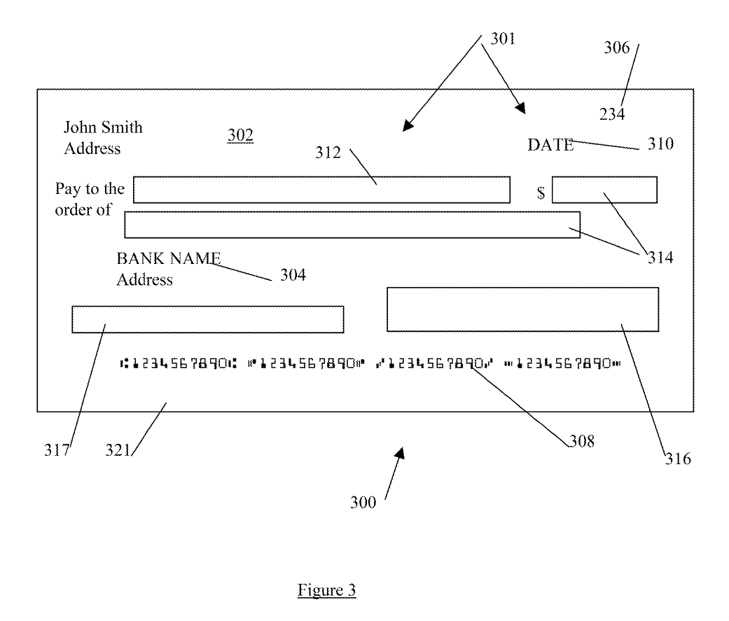

Referring to FIGS. 2 and 3, the electronic negotiable instrument 300 can be represented as the electronic file 320 first issued (either sent to the computing device 101 of the payor 102 or hosted remotely by the financial institution 110) by the financial institution 110 to the customer 108 (e.g. payee). The electronic file 320 can include payment data 322 and generation data 324 (e.g. image data) for use in generating the resultant electronic negotiable instrument 300, once specific data values (e.g. date, monetary amount, etc.) are added to the payment data 322 by the user. The payment data 322 and the generation data 324 could be defined in a structured definition language such as XML, a series of instructions (e.g. script), or a combination thereof. For example, the structured definition language would define the payment 322 and generation 324 data as a series of metadata records, which consist of a number of pre-defined elements representing specific attributes of a resource such that each element can have one or more values.

The electronic file 320 can be referred to as a package of information with a name or other file identification (e.g. instrument number 306—see FIG. 3) attached to it, such that the electronic file 320 can contain/record data associated with the electronic negotiable instrument 300, such as text and/or numbers. The electronic file 320 (and negotiable instrument 300) can contain ways to perform various processing procedures on data, such as as programs and/or commands. It is recognised that the electronic file 320 can be an entity of data available to the computing device 101 (see FIG. 5) users (including the system itself and its application programs 326), and is capable of being manipulated as an entity (for example, moved from one file directory to another). The electronic file 320 has the unique name within its own directory. The operating systems of the computing device 101 and the processing applications 226 can describe the electronic files 320 with given formats by giving them a particular file name suffix (e.g. file name extension.). For example, a program or executable file as the electronic file 320 could be given or required to have an “.exe” suffix.

In the case where the electronic file 320 is used to generate the electronic negotiable instrument 300, rather than become the electronic negotiable instrument 300, the electronic file 320 could be embodied as a one-time use executable as provided by the financial institution 110. Once used, the executable electronic file 320 would be disgarded by the user or the financial institution 110. In a further embodiment, the electronic file 320 may be configured as a limited reusable executable for use in generating a predefined limited number of different electronic negotiable instruments 300 before becoming inoperable or otherwise discarded. In a further embodiment, the electronic file 320 may be configured as a limited reusable executable for use in generating an unlimited number of different electronic negotiable instruments 300, either unlimited in time, or limited for a specific time and/or calendar period, as desired. In any event, it is recognised that the electronic document 320 could either be executed to turn into the electronic negotiable instrument 300 or be used to generate a separate electronic negotiable instrument 300, as desired, with assistance of the generation data 324 (as part of or in addition to the electronic file 320). For example, the electronic file 320 could be referred to as the payor account 500 that is used to generate a limited number of electronic negotiable instruments 300 identified by one another by individual instrument numbers 306. For example, the electronic file 320 could contain a list of the individual instrument numbers 306 as a summary of the contents of the electronic file 320, and as such the summary could indicate whether specific instrument numbers 306 have already been used to generate the electronic negotiable instruments 300 or are still available to do so.

The generation data 324 can be used: in the electronic file 320 to help facilitate entry of the data values by the user into the payment data 322 definitions of the electronic file 320 to result in generation of the electronic negotiable instrument 300; in the negotiable instrument 300 help facilitate presentation of the electronic negotiable instrument 300 as a reproducible image 321 (e.g. cheque); or a combination thereof. It is recognised that the generation data 324: can include the specific definitions/instructions used to generate the electronic negotiable instrument 300 and/or generate the reproducible image 321; can include only a reference to a processing application 326 having the definitions/instructions used to facilitate generation of the electronic negotiable instrument 300 and/or facilitate generation of the reproducible image 321; or a combination thereof. As well, it is recognised that the generation data 324 could include reference to the generation application 326 configured for facilitating entry of specific data values by the user into the payment data 322 for inclusion in the electronic negotiable instrument 300. For example, in the case of the payor account 500, the generation data 324 could include a wizard hosted on the financial institution's 110 website that assists in filling out of the fields 301 (see FIG. 3) needed from the electronic file 320.

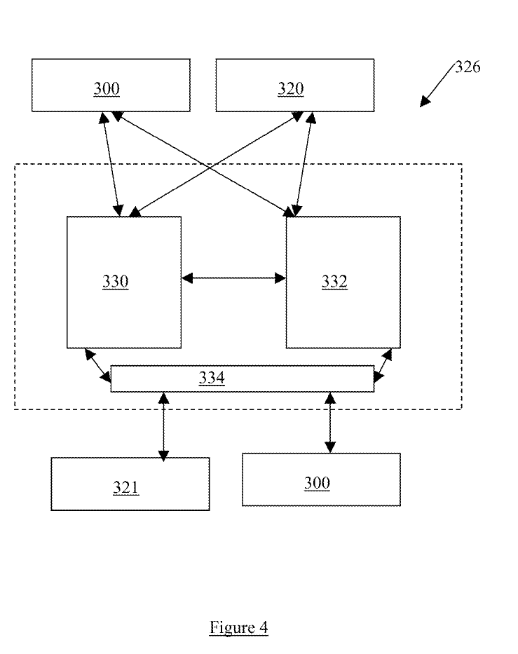

For exemplary purposes only, the discussion of the following embodiment includes the payment data 322 definitions and generation data 324 definitions/instructions in the electronic file 320 itself, i.e. a self contained electronic file 320 that is executable by the user for use in generation of the corresponding electronic negotiable instrument 300 by having filled in fields 301 (see FIG. 4) such as monetary amount and payee, as further described below.

### Electronic File 320

### Payment Data 322

Referring to FIGS. 2 and 3, the structured definition language for the payment data 322 may include data definitions (e.g. numbers, text strings, etc. with tag delimiters) for a number of data fields 301 such as but not limited to: identification of the issuing financial institution of the electronic negotiable instrument 300; instrument number 306; account number 308 such as MICR including bank transit number and routing information); date of issue 310 (for present or post-dated); payee 312 name; monetary amount and kind of currency 314 (e.g. written numerically and/or through words); and a unique identifier 316 (e.g. signature) of the payor. It is recognised that the payment data 322 can also contain information that would not be displayable in the reproducible image 321, including information such as but not limited to: a time/date that the electronic negotiable instrument 300 was created; to whom the electronic negotiable instrument 300 was issued; and a date/time that the electronic negotiable instrument 300 was executed (e.g. filled out) by the payer.

It is also recognised that the unique identifier 316 representing the signature/authorization for the electronic negotiable instrument 300 could contain a verification component issued by the financial institution 110 (or other trusted third party) that would be used to authenticate the digital signature of the user/payer filling out the data fields 301 of the electronic file 320. This verification component could also be supplied as identifying the listed owner of the computing device 101 used to process the electronic file 320, in generation of the corresponding electronic negotiable instrument 300. For example, if an actual electronic written signature of the payer is not added to the payment data 322 as the unique identifier 316, then a visual embodiment of the verification component would be imaged adjacent to (or otherwise associated with) the unique identifier 316 (e.g. printed name of the payer) in the reproducible electronic image 321. The visual embodiment of the verification component in addition to the unique identifier 316 of the user/payer would be recognized in the reproducible electronic image 321 as the required signature needed by the electronic negotiable instrument 300 when in paper/image form.

### Generation Data 324

The structured definition language (and/or instructions) for the generation data 324 may include data definitions (e.g. numbers, text strings, etc. with tag delimiters) such as but not limited to: colors, fonts, layout, and other aspects of appearance/presentation (e.g. pictures, etc.) of the payment data 322 when presented as the reproducible image 321. The generation data could include an image of the payer's written signature, as desired. As well, the generation data 324 could contain definitions for the background image 302 (e.g. personalized cheque background including artwork, designs, ect.) of the electronic negotiable instrument 300.

Further, it is recognised that the generation data 324 could specify the behaviour/execution of the electronic file 320 when being filled out by the payer (e.g. filling out payee name and monetary amount, etc.). This behaviour controlling generation data 324 may not be included as part of the reproducible image 321, and/or the electronic negotiable instrument 300 (i.e. the specific generation data 324 for facilitating the behaviour of the electronic file 320 would not be transferred or otherwise included in the electronic negotiable instrument 300), but would be used in entering specific data values by the user/payer into the payment data 322 definitions.

The generation data 324 can include definitions for actions/controls such as but not limited to: GUI screens, controls, and actions to be executed when the user interacts with electronic file 320 when using the user interface 202 (see FIG. 5). For example, the generation data 324 may define screens, labels, edit boxes, buttons and menus, and actions to be taken when the user types in an edit box or pushes a button. In the case where the generation data 324 is used to assist in generation of the electronic negotiable instrument 300, menus can be presented to the user to help in selection of data for the respective fields 301 (see FIG. 3). For example, the menus can include predefined selections for currency type, payers, payees, dates, etc, such that the predefined selections are determined by the financial institution 110 or other third party issuing the electronic file 320. It is also recognised that the generation data 324 could be used to facilitate error checking in the payment data 322 values entered by the user, as desired.

### Electronic Negotiable Instrument 300

It is recognised that the behavioural aspects of the generation data 324 (e.g. controls, menus, ect.) for filling in the data values for the payment data 322 may not be included in the generated electronic negotiable instrument 300, as desired. Further, it is recognised that the electronic negotiable instrument 300 would include at least some of the payment data 322 of the electronic file 320 (filed 301 definitions for example). One embodiment is that the payment data 322 of the electronic negotiable instrument 300 would be written in the structured definition language (e.g. XML or a derivative/version thereof) with the corresponding data values inserted therein.

Some of the generation data 324 of the electronic file 320 could be included in the negotiable instrument 300, and/or additional generation data 324 created during execution of the electronic file 320 could be included, as desired. For example, the generation data 324 in the negotiable instrument 300 could include a reference to a secondary formatting document (e.g. XSL style sheet) containing the definitions/instructions for configuring the appearance of the payment data 322 in the reproducible image 321, used to visually present the payment data 322 as a visually recognisable version of the negotiable instrument 300 on a display interface 202 of the computing device 101 (see FIG. 5). It is also recognised that the negotiable instrument 300 could contain some of or all of the formatting definitions/instructions for creating the reproducible image 321, as desired.

### Processing Application 326

Referring to FIG. 4, the processing application 326 could be embodied as one or more applications responsible for any one or more of: generation of the electronic negotiable instrument 300 from the electronic file 320; and generation of the reproducible image 321 from the electronic negotiable instrument 300. The application 326 can be operable by the respective computing device 101 (see FIG. 5), either locally and/or remotely, and can include a payment module 330 for reading the payment data 322 and for coordinating insertion of the entered data values into the corresponding locations in the payment data 322. The application 326 can also have a processing module 332 (or as a separate application) for interpreting the generation data 324 to provide user interface features on the user interface 202 (see FIG. 5) for facilitating entry of the data values provided by the user/payer in processing of the electronic file 320. The application 326 can also have a generation module 334 configured for combining the payment data 322, the generation data 324, and the specific data values therefore in order to generate the corresponding electronic file 320 and/or electronic negotiable instrument 300, as appropriate.

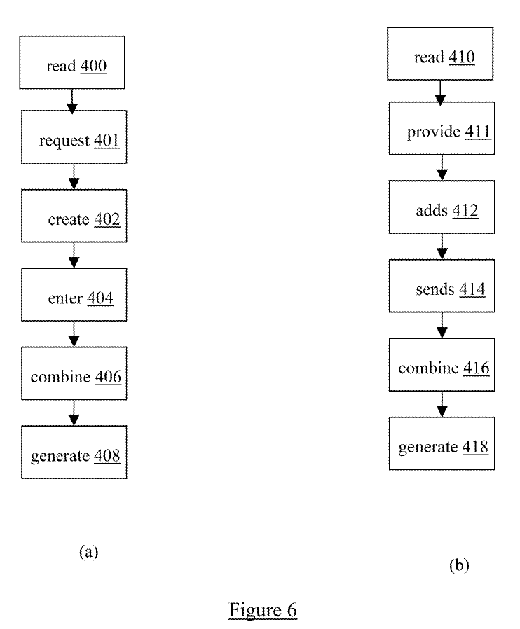

For example, referring to FIGS. 4 and 6a,b, the payment module 330 reads 400 the payment data 322 of the electronic file 320 to determine what values are required to be filled in. The payment module 330 requests 401 these values from the processing module 332, which then creates 402 and displays the corresponding data entry requirements on the user interface 202 of the computing device 101 (see FIG. 5). Once the user enters 404 the data values, the generation module combines 406 appropriate data 322,324 and entered data values and generates 408 the electronic negotiable instrument 300. In this case, the processing module 332 would be used to format the payment data 322 contents of the electronic file 320, according to the colors, fonts, layout, and other aspects of document presentation (e.g. pictures, etc.) defined by the generation data 324, to assist in generation of the electronic negotiable instrument 300.

Referring again to FIGS. 4 and 6a,b, the payment module 330 reads 410 the payment data 322 of the electronic negotiable instrument 300 to determine what values are required to be presented on the display of the user interface 202 (see FIG. 5). The payment module 330 provides 411 these data values to the processing module 332, which then adds 412 the corresponding generation data 424 for formatting the reproducible image 321. The processing module 322 sends 414 the data 322,324 and data values as appropriate to the generation module 334, which combines 416 the appropriate data 322,324 and entered data values and generates 418 the reproducible image 321 on the user interface 202 of the respective computing device 101 (see FIG. 5). In this case, the processing module 332 would be used to format the payment data 322 contents of the electronic negotiable instrument 300, according to the colors, fonts, layout, and other aspects of document presentation (e.g. pictures, etc.) defined by the generation data 324, to assist in generation of the reproducible image 321. The reproducible image 321 could also be sent to a printer (not shown) connected to the computing device 101, in order to produce a paper document of the reproducible image 321 that would be recognized as legal tender.

### Types of Electronic Negotiable Instrument 300

The electronic negotiable instrument 300 is a transferable, signed electronic document that promises to pay the bearer a sum of money at a future date or on demand. Examples include cheques, bills of exchange, and promissory notes. The electronic negotiable instrument includes components, such as but not limited to:

1. an unconditional promise or order to pay (e.g. from a payer);

2. the payment is in a specific sum of money, although interest may be added to the sum;

3. the payment is a promise for payment defined as to be made on demand or at a definite time (e.g. future date);

4. the electronic negotiable instrument 300 is payable to the holder, bearer or to order (e.g. payee);

5. the account of a financial institution 110 is specified as the source of release of the payment to the holder, bearer or to order; and

5. the electronic negotiable instrument 300 does not state any other undertaking or instruction by the person promising or ordering payment to do any act in addition to the payment of the specific sum of money.

Further, it is recognised that the electronic negotiable instrument 300 defines a financial transaction that is one of ‘push’ versus ‘pull’. That is, electronic negotiable instrument 300 (e.g. a cheque) is a ‘pull’-initiated transaction, such that the presentation of the electronic negotiable instrument 300 by the payee causes the payee's financial institution 110 to seek the funds from the payer's financial institution 110, which then takes the corresponding funds from the payer's account if the funds exist. In the case of a personal cheque as the electronic negotiable instrument 300, if the funds do not exist, then the cheque “bounces” and is returned to the payee with a message of insufficient funds. It is recognised that one advantage of the electronic negotiable instrument 300 is that transfer of the specific sum of money specified does not actually occur until the electronic negotiable instrument 300 is presented by the holder to a financial institution 110, as compared to other financial transactions that occur without delay (e.g. debit or interact transactions for example). In the case of future or post dated electronic negotiable instruments 300, there is a predefined minimum time lag between providing of the electronic negotiable instrument 300 by the payer to the payee and presentment of the electronic negotiable instruments 300 by the payee to the respective financial institution 110.

Referring to FIG. 3, the electronic negotiable instrument 300 can contain fields 301 (e.g. a unit of data) having an area in a fixed or known location in the electronic negotiable instrument 300, such as a record, message header, or computer instruction that has a purpose and can have a fixed size. It is recognised that the fields 301 can be subdivided into smaller fields, desired. The electronic negotiable instrument 300 can contain any of the following fields 301, such as but not limited to:

1. background (e.g. artwork oro other visual design aspects) 302;

2. place of issue 304 (e.g. identification of issuing financial institution 110);

3. instrument number 306;

4. account number 308 (e.g. MICR including bank transit number and routing information);

5. date of issue 310 (for present or post-dated);

6. identification of payee 312;

7. amount of currency 314;

8. unique identifier 316 (e.g. signature) of the drawer/payee;

9. memorandum 317 indicating nature/purpose of the instrument as a convenience without affecting the official parts of the instrument; and

10. position 318 for endorsement if required (e.g. place for payee signature on back of a cheque).

It is recognised that printing of the electronic negotiable instrument 300 could be done so as to recognise MICR numerals and control characters of the account number 308 stored in the data 322,324 of the electronic negotiable instrument 300. For example, the data 322,324 of the electronic negotiable instrument 300 could define which of the characters should be printed using magnetic particles, in order to properly reproduce a paper version of the reproducible image 321. The data 322,324 could define the unique fonts of the MICR characters, as well as instructions specified for use by the printer to print the MICR characters with magnetic particles (e.g. ink or toner). In general, magnetic printing is used so that the characters can be reliably read into cheque reader (not shown), even when the MICR characters have been overprinted with other marks such as cancellation stamps. The MICR characters can include digital characters containing the issuing bank's Aba Transit Number (bank identifier) and Check Routing Symbol (denoting funds availability).

### Cheque

A cheque is one payment form that the electronic negotiable instrument 300 can be used to represent. In general, a cheque is a promise for payment from the payer to the payee and can be valid for a predefined period of time (e.g. six months) after the date 310 of issue unless otherwise indicated. For example, a cheque can be defined as a negotiable instrument instructing a financial institution 110 to pay a specific amount of a specific currency from a specific demand account (containing deposited funds) held in the maker/depositor's name with that institution. Both the maker and payee may be natural persons or legal entities. Checks are negotiable by Endorsement and delivery (also called Presentment) to the paying bank, which is then obligated to pay the check. If an instrument is payable to the bearer, for example, a bearer stock or bearer bond, negotiation is done by simply presenting the instrument.

Further, an individual could use a cashier's check instead of a personal check to guarantee that his or her funds for payment are available. A cashier's check is secured because the amount of the check must first be deposited by the individual into the issuing institution's account. The person or entity to whom the check is made out is then guaranteed to receive the money when cashing the check. The cashier's check is a check issued by a bank on its own account for the amount paid to the bank by the purchaser with a named payee, and stating the name of the party purchasing the check (the remitter). The check is received as cash since it is guaranteed by the bank and does not depend on the account of a private individual or business. Cashiers' checks are commonly used for business, real estate transfers, tax payments and other financial transactions where a promise of payment can be used as payment.

### Promissory Note

A promissory note is another payment form that the electronic negotiable instrument 300 can be used to represent. The promissory note is adocument signed by a borrower promising to repay a loan under agreed-upon terms, also called note, which is a written promise by the maker to pay money to the payee. The most common type of promossory note is a bank note, which is defined as a promissory note made by a bank and payable to bearer on demand

### Bill of Exchange

A bill of exchange is another payment form that the electronic negotiable instrument 300 can be used to represent. The bill of exchange is an unconditional written order issued by a person or business which directs the recipient to pay a fixed sum of money to a third party at a future date. The future date may be either fixed or negotiable. The bill of exchange can include written data and is signed and dated, also called a draft. The bill of exchange, which is a written order by the drawer to the drawee to pay money to the payee. The most common type of bill of exchange is the cheque, which is defined as a bill of exchange drawn on a banker and payable on demand. Bills of exchange are used primarily in international trade, and are written orders by one person to pay another a specific sum on a specific date sometime in the future.

### Travellers Cheque

A travellers cheque is another payment form that the electronic negotiable instrument 300 can be used to represent. The travellers cheque is a letter of credit issued by a bank or express company that is a promise of payment payable on presentation to any correspondent of the issuer. This type of check can be issued by a financial institution (e.g. credit lending institution) such as American Express, Visa, or Mastercard that allows travelers to carry travel funds in an alternative to cash. The traveler buys the checks, for a nominal fee, with cash, a credit card, or a regular check at a bank or travel service office and then signs each traveler's check. The check can then be used virtually anywhere in the world once it has been countersigned with the same signature. The advantage to the traveler is that the traveler's check cannot be used by someone else if it is lost or stolen, and can be replaced usually anywhere in the world. Traveler's checks can be issued in many foreign currencies, allowing a traveler to lock in at a particular exchange rate before the trip begins. Issuers of traveler's checks can offer a type of check that enables two travelers to share the same travel funds. As the travellers cheque is a promise of payment, institutions issuing traveler's checks can profit from the float earning interest on the money from the time the customer buys the check to the time they use the check as payment. In this case, the data 322,324 also contains an original signature of the payee (as verified by the financial institution 110) before the corresponding electronic file 320 is transmitted (uploaded or downloaded) to the computing device 101 of the user (e g. payee).

It is recognised that credit card cheques (e.g. VISA) are another payment form that the electronic negotiable instrument 300 can be used to represent. The credit card cheques are honored by the credit card companies as the amount of the cheque is withdrawn from the user's credit card account when the credit card cheque is presented as payment.

### Other

The following is a non-exhausible list of further payment forms that the electronic negotiable instrument 300 can be used to represent, such as but not limited to: bank check, check; bill of exchange, draft, order of payment for ordering the payment of money drawn by one person or bank on another; counter check as a blank check provided by a bank for the convenience of customers who are making withdrawals; giro, giro cheque as a check (e.g. given by the British government) to someone who is unemployed that can be cashed either at a bank or at the post office; paycheck, payroll check used as a check issued in payment of wages or salary; certified cheque used as a check containing certification that the person who issued the check has sufficient funds on deposit to cover payment; personal cheque used as a check drawn against funds deposited in one's own personal checking account; cashier's cheque, treasurer's check, treasurer's cheque used as a check issued by an officer of a bank on the bank's own account (not that of a private person); blank cheque used as a check that has been signed but with the amount payable left blank; medicare cheque/payment used as a check reimbursing an aged person for the expenses of health care; and a tele-cheque.

It is recognized that the tele-cheque can be a paper payment item that resembles a cheque except that it is neither created nor signed by the payer (i.e. the person from whose account the funds would be debited). Instead, the tele-cheque is created, and may be signed, by a third party on behalf of the payer who has purportedly authorized the withdrawal from his or her account over the telephone or the Internet, for example. Furthermore, the tele-cheque is not supported by any agreement signed by the account holder to authorize the withdrawal of funds from his or her account. Consequently the account holder's financial institution has no means of confirming that its customer authorized the payment.

### Virtual Check Book 500

Referring to FIG. 7, shown is a further embodiment of the payment environment 100 of FIG. 1. In particular, shown is a payor account 500 (e.g. a virtual checkbook) that is hosted by the financial institution 110 having the payor 102 as a customer, such that the electronic files 320 are not downloaded to the payor 102 and can be instead accessed remotely over the network 11 by the payor 102 when browsing the financial institution's 110 website. The financial institution 110 Web site can also be represented as a computing framework (e.g. Web service) for communication with the payee 118 and the payor 102 over the network 11, for use in setting up payor/payee accounts, coordinating the completion of the payment data 322 for the electronic negotiable instrument 300 online by the payor 108, and communication with the payee 118 for being informed and then accessing electronically the electronic negotiable instrument 300 over the communications network 11. The payor account 500 is used to hold one or more of the electronic files 320 (e.g. as individual cheques) that can be filled out by the payor 102 online and then be used to generate the corresponding electronic negotiable instrument(s) 300 that is/are then made available to the intended payee 118 (or payees 118) over the network 11 from the financial institution 110 (for example), as further described below. The payor account 500 can be used by the payor 102 also as an online tool to record and maintain information about their financial instrument 300 (e.g. checking) account such as: balance; deposits; withdrawals; availability of unused financial instruments 300; and other account functions. It is recognized that the payor account 500 is registered with the financial institution 110 with an assigned payor account number/identification and password protected (e.g. via a payor issued PIN). For example, the customer/payor 102 requests via the request message 104 that the payor account 500 be set up with one or more electronic files 320 by the financial institution 110 (or other associated third party 112), which are suitable for generation of electronic negotiable instruments 300 to specified payees 118. In any event, it is recognized that the payor account 500 contains electronic file(s) 300 that can be used to generate one or more of the electronic negotiable instruments 300 to an intended payee 118 for an appropriate amount.

As described above, the electronic files 320 contain a number of fields 301 for use in generating the electronic negotiable instruments 300. An example of the negotiable instrument fields 301 is shown in FIG. 3, such that some of the fields 301 are configured by the financial institution 110 (e.g. instrument number 306, account number 308) for the electronic files 320 resident in the payor account 500, and others of the fields 301 are filled in remotely by the payor 102 (e.g. selected payee 118 for a specified amount 314 as of a certain date 310) in use of the present electronic files 320 in causing the corresponding electronic negotiable instrument 300 to be made available to a selected payee 118 for the specified amount 314 as of the certain date 310.

For example, the payor account 500 can contain a number of electronic files 320, such that each has the specified instrument number 306 (e.g. similar to a check number), see FIG. 3. The payor 102 accesses (for example by instrument number 306 listed in the payor account 500) and fills out the information required for each of the fields 301 of the electronic files 320 in order to cause the corresponding negotiable instrument 300 to be generated. The payor 102 also indicates a mode of communication 502 to be associated with the corresponding negotiable instrument 300, such that the mode of communication 502 specifies a contact method (e.g. telephone number, facsimile, email address, etc.) for the listed payee 118 on the corresponding negotiable instrument 300. The mode of communication 502 can contain details of the payee (e.g. name, address, etc.), the network 11 address of the target computing device 101 to be ultimately receiving the corresponding electronic negotiable instrument 300, and other payee 118 contact information as desired. The payor 102 can also supply a unique identification number (e.g. PIN) or alphanumeric string 504 for use by the payee 118 in digitally accessing the resultant electronic negotiable instrument 300 that is made out to the payee 118.

For example, once the payor 102 has filled out the corresponding fields 301 for a specific payee 118, the financial institution 110 sends an instrument message 506 to the payee 118 over the network 11 using the specified mode of communication 502 (e.g. email address) and includes the unique identification number 504 associated with the electronic negotiable instrument 300 as well as the network address 508 of the financial institution 110 holding the resultant electronic negotiable instrument 300 made out to the payee 118. The payee 118 then obtains the unique ID 504 from the instrument message 506 and then accesses the specified the network address 508 of the financial institution 110 to request a download message 510 to the payee 118 computing device 101. The payee 118 would also provide the corresponding unique ID 504 to the financial institution 110 in order to help facilitate including the electronic negotiable instrument 300 in the download message 510 this forwarded over the network 11 to the specified address of the payee 118 (e.g. the payee's email address). In one example, the mode of communication 502 could be a telephone number, the payee 118 could then access the website via the network 11 of the financial institution 110 identified in the verbal instrument message 506, and the payee 118 would then provide the unique identification number 504 as well as a sufficient network 11 address (e.g. email address) by which to receive the electronic negotiable instrument 300. At this point it is recognized that the electronic negotiable instrument 300 is capable of being processed by the financial institution 110 of the payee 118, i.e. deposited electronically as envisioned by facilitating the elimination of the need for paper based check payment origination and can take advantage of all existing paper based check payment legislation (such as Check 21 in the US), systems, IRD, networks, policies, processes and procedures, for example.

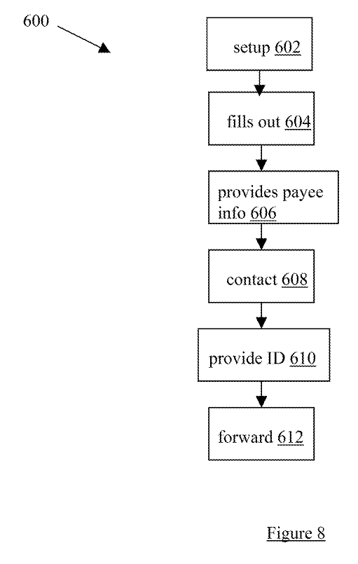

Referring to FIGS. 7 and 8, shown is an example operation 600 of the system 100 shown in FIG. 7. At step 602, the payor 102 sets up their account 500 with the financial institution 110, including a number of specified electronic file(s) 320 for use in generating the negotiable instruments 300. The payor 102 is assigned a user ID and a password for accessing the payor account 500 via the financial institution 110 website over the network 11. At step 604, the payor 102 accesses their account 500 online and fills out the fields 301 (see FIG. 3) of a selected financial instrument number 306 for use in generating at least one of the negotiable electronic instruments 300 for a selected payee 118. The payor 102 can also provide 606 the unique identification number 504 (or as specified at least in part by the financial institution 110) for use by the payee 118 in retrieving the corresponding negotiable electronic instruments 300, as well as mode of communication 502 for use in contacting the payee 118 that the corresponding negotiable electronic instrument 300 is available. The financial institution 110 then contacts (e.g. sends a network message) 608 the payee 118 via the mode of communication 502 and informs the payee 118 of the available negotiable electronic instrument 300, including the unique identification number 504. The payee 118 then contacts (e.g. sends a request) 610 the financial institution 110 (for example by logging in to their own financial institution account on the financial institution 110 website) and provides the unique identification number 504. The financial institution 110 then authenticates the payee 118, for example using the supplied unique identification number 504, and then forwards 612 the available negotiable electronic instrument 300 to the supplied network 11 address (e.g. of the payee 118). The supplied address could be included as part of the payee 118 request and/or be part of the financial institution account information of the payee/payor. The payee 118 is then able to present the received negotiable electronic instrument 300 to a financial institution 110 of their choice for subsequent processing as an electronic payment.

### Computing Devices 101

Referring to FIGS. 1 and 5, each of the above-described components of the payment system 10, i.e. customers 102, financial institution 110, third party 112, payee 118, and certification authority 120 can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the network 11 (e.g. an intranet and/or an extranet such as the Internet), which enables the devices 101 to communicate with each other as appropriate. The network 11 can support transfer of the electronic files 320 and the electronic negotiable instruments 300 between the customers 102, financial institution 110, third party 112, payee 118, and certification authority 120.

Referring again to FIG. 2, the devices 101 can also have a user interface 202, coupled to the device infrastructure 204 by connection 222, to interact with a user (e.g. payer, payee, etc.). The user interface 202 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the customers 102 can be configured to interact with web browsers (applications 17) to access the electronic files 320 via websites 116 (see FIG. 1) of the financial institution 110, as well as send the resultant electronic negotiable instruments 300 to the payee 118. Further, the user interface 202 can work in conjunction with a processing application 326 to process the electronic file 320 to produce the electronic negotiable instruments 300, as further described above.

Referring again to FIG. 2, operation of the device 101 is facilitated by the device infrastructure 204. The device infrastructure 204 includes one or more computer processors 208 and can include an associated memory 210 (e.g. a random access memory or permanent storage). The computer processor 208 facilitates performance of the device 101 configured for the intended task (e.g. customers 102, financial institution 110, third party 112, payee 118, and certification authority 120) through operation of the network interface 200, the user interface 202 and other application programs/hardware of the device 101 by executing task related instructions. These task related instructions can be provided by an operating system, and/or software applications 326 located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update applications 326. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination. It is recognized that the memory 210 can be used to store the electronic files 320 and/or the generated electronic negotiable instruments 300, as desired.

Further, it is recognized that the computing devices 101 can include the executable applications 326 comprising code or machine readable instructions for implementing predetermined functions/operations including those of an operating system, a web browser, processing of the electronic files 320 and generation of the electronic negotiable instruments 300, for example, in response user command/input. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality of the customers 102, financial institution 110, third party 112, payee 118, and certification authority 120 provided by the systems and process of FIGS. 1 to 6 may be implemented in hardware, software or a combination of both. Accordingly, the use of a processor 208 as a device and/or as a set of machine-readable instructions is hereafter referred to generically as a processor/module for sake of simplicity.

Further, it is recognised that the financial institution 110 can include one or more of the computing devices 101 (comprising hardware and/or software) for implementing the modules 330, 332, 334 as desired.

It will be understood that the computing devices 101 may be, for example, personal computers, personal digital assistants, mobile phones, and content players. Server computing devices 101 (e.g. for the financial institution 110) may additionally include a secondary storage element such as a memory 308 (e.g. database). Each server, although depicted as a single computer system, may be implemented as a network of computer processors, as desired.

It will be understood by a person skilled in the art that the memory 102 storage described herein is the place where data is held in an electromagnetic or optical form for access by a computer processor. In one embodiment, storage means the devices and data connected to the computer through input/output operations such as hard disk and tape systems and other forms of storage not including computer memory and other in-computer storage. In a second embodiment, in a more formal usage, storage is divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be much faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is a further embodiment of memory 102 as a collection of information that is organized so that it can easily be accessed, managed, and updated. In one view, databases can be classified according to types of content: bibliographic, full-text, numeric, and images. In computing, databases are sometimes classified according to their organizational approach. As well, a relational database is a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Computer databases typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory is a further embodiment of memory 210 storage as the electronic holding place for instructions and data that the computer's microprocessor can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

1. A method for providing an electronic negotiable instrument as a promise for payment for a selected payee over a communications network, the method comprising:
generating the electronic negotiable instrument for the selected payee with instrument information from a payor;
receiving a specified mode of communication associated with the payee; and
sending a message to the selected payee over the communications network using the specified mode of communication to inform the payee of the availability of the electronic negotiable instrument.

2. The method of claim 1, wherein the specified mode of communication includes an address of the communications network for a connected target device.

3. The method of claim 1 further comprising: receiving a request over the communications network from the payee for the electronic negotiable instrument;
authenticating the payee request and a specified receipt address; and forwarding the electronic negotiable instrument over the communications network to the specified receipt address.

4. The method of claim 3, wherein the specified mode of communication is different from the specified receipt address.

5. The method of claim 3, wherein the specified receipt address is that of a target device of the payee.

6. The method of claim 1 further comprising including a unique identifier in the message for use by the payee in accessing the electronic negotiable instrument, such that the unique identifier is used in authentication of the payee when requesting the electronic negotiable instrument.

7. The method of claim 6, wherein the unique identifier includes an instrument number of the electronic negotiable instrument, the instrument number one of a plurality of instrument numbers of possible electronic negotiable instruments in an account of the payor.

8. The method of claim 6, wherein the unique identifier is initially supplied by the payor.

9. The method of claim 3 further comprising including a unique identifier in the message for use by the payee in accessing the electronic negotiable instrument, such that the unique identifier is used in the authentication of the payee.

10. The method of claim 3, wherein both the payee and the payor have account information stored in a database for use in generation of the electronic negotiable instrument and for use in accessing of the generated electronic negotiable instrument.

11. The method of claim 10, wherein the payee and payor account information are held by a financial institution, the financial institution monitoring the generation and subsequent accessing of the electronic negotiable instrument through a network interface with the communications network.

12. The method of claim 10, wherein the network interface is a Web site of the financial institution.

13. The method of claim 11, wherein the electronic negotiable instrument is an electronic file includes a digital certificate issued by a certification authority.

14. The method of claim 13, wherein the digital is associated with the financial institution.

15. The method of claim 1, wherein the electronic negotiable instrument is an electronic file including payment data and generation data, the generation data including image data for use in providing a reproducible image of the electronic negotiable instrument, the reproducible image according to a predefined standard.

16. The method of claim 15, wherein the payment data and the generation data are defined in a structured definition language.

17. The method of claim 15, wherein the electronic file is a one-time use executable for use in generating the electronic negotiable instrument.

18. The method of claim 15, wherein the electronic file is a limited use reusable executable for use in generating a number of different ones of the electronic negotiable instrument for different payment amounts.

19. A framework for implementing the steps of claim 1, the framework coupled to the payee and the payor through the communications network.
